(19) United States
(12) Patent Application Publication
(10) Pub. No.: US 2018/0276750 A1
(43) Pub. Date: Sep. 27, 2018

(54) Methods for modeling credit risk metrics of publicly traded companies in a shot noise market

(71) Applicants: Nick Laskin, Toronto (CA); Rodion Remorov, Vaughan (CA)

(72) Inventors: Nick Laskin, Toronto (CA); Rodion Remorov, Vaughan (CA)

(21) Appl. No.: 15/469,199

(22) Filed: Mar. 24, 2017

(51) Int. Cl. G06Q 40/04; G06F 17/10

(52) U.S. Cl. CPC G06Q 40/04; G06F 17/10

(57) ABSTRACT

Computer-implemented methods are proposed for modeling credit risk metrics of publicly traded companies. The company is characterized with an asset value modeled by superposition of two Geometric Shot Noise random processes. The credit risk metrics include Probability of Default, Distance to Default, Credit Spread, Expected Credit Loss, and Recovery Rate. The proposed analytical structural default model is designed based on options pricing equation obtained by using superposition of two Geometric Shot Noise processes with market memory. The methods define three modes for calculating the credit risk metrics: a double jump mode, a jump-diffusion mode, a diffusion mode. Each mode is characterized with market memory due to autocorrelation of stock price returns empirically observed in the markets. Market memory has two limitation cases: long memory and short memory. For each of the above modes, the long memory case initiates a coherent sub-mode, while the short memory case initiates a memoryless sub-mode.

### FIELD OF THE INVENTION

The instant invention relates to data processing systems and methods specially adapted for financial or forecasting purposes, particularly for calculating credit risk metrics of publicly traded companies. The invention discloses a new analytical structural default model and its implementations based on computer-aided techniques for calculating probability of default, a distance to default, a company's credit spread, expected credit loss, and a recovery rate of publicly traded companies using data streams from various market data vendors.

### BACKGROUND OF THE INVENTION

### I. Basic Definitions

The following terms are defined in the present disclosure:

I-1. A standard Wiener Process W (t) is a continuing time random process with W(t=0)=0 and independent Gaussian increments W(t)−W(s) with a mean equal 0 and variance t−s for any time moments s and t, 0≤s<t. [1] (all references in brackets [ ] are listed at the end of present description).

I-2. A Poisson probability distribution is a discrete probability distribution that expresses the probability of a given number of events occurring in a fixed interval of time if these events occur with a known average rate and independently of the time since the last event [2, 3].

I-3. A shot noise is a random process, which models jump-like pattern of stock prices. A shot-noise process F (t) is defined by the following formula [22]

$$F ( t ) = {\sum }_{k = 1}^{n} {η}_{k} ϕ ( t - {t}_{k} ) ,$$

where random jumps of stock prices ηₖ are statistically independent and distributed with a probability density p(η), random points tₖ ace homogeneously distributed on a time interval [t,T], so that their number n obeys Poisson's probability distribution, and a deterministic function φ(t) is a response (or memory) function (φ(t)=0 for t<0). The shot-noise process F(t) describes an impact of different fluctuating market factors on a company's asset value V.
A company's asset value V is defined as a sum of the company's equity S and debt D, such that V=S+D.

I-4. Default Risk is defined as any risk, at which a company will not be able to service its debts and meet its obligations. Until a default event has been occurred it is impossible to distinguish between companies that will default and those that won't. As a consequence, it is only possible to make probabilistic assessments that the company will default. To cover lenders for this uncertainty, companies generally pay a spread over the default-free rate of interest that is proportional to their probability of default [4].

I-5. Default Barrier D is a company's characteristic, which can be determined from the structure of the company's debt. Different structural models make different assumptions about how the default barrier D is determined. For example, KMV [5] puts the value D between the face value of a short term debt, and the face value of the total debt, arguing that the company will always have to service short term debt, but can be more flexible in servicing the long term debt. In the KMV model, the Default Barrier D is given by the full short term debt plus half the long term debt [5]. If a company's asset value V(t) falls below a Default Barrier D at the time of long term debt's maturity t=T, V(T)<D, then the company cannot repay its bondholders and the company defaults.

I-6. Company's Equity as European Option Value.

A company's equity can be considered as an European call option on the company's value V with a strike equal to a face value of the company's debt D. This is known as Merton's model [6].

I-7. Efficient Market Hypothesis (EMH) [4] is an idealistic theoretical economical concept stating that it is impossible to “beat the market” because a so called “efficient” stock market causes an instant sharing (propagating) of information and stock prices always incorporate and reflect all relevant information at any given moment. Due to such “efficiency” of the market, stocks always trade at their fair value on stock exchanges, making it impossible for investors to either purchase undervalued stocks or sell stocks for inflated prices. Consequently, it's impossible to outperform the overall market through stock selection or market timing, and that the only way to make a profit is the purchasing riskier stocks/financial instruments.

I-8. Memory Effect of a stock market is an autocorrelation of a current value of stock price return wherein the value of stock price return is taken at some previous moment of time, i.e. a past value of the stock price. A typical autocorrelation time varies from intraday to monthly time intervals. Taking into account the Memory Effect of stock market for calculating credit risk metrics of a publicly traded company is an innovative feature of the present invention. The stock market's Memory Effect is modeled by means of a response function to the stock returns. A stock market with the Memory Effect is herein also called a “stock market with memory”. The key parameter of the response function is a characteristic autocorrelation time.

I-9. Coherent Market & Memoryless Market. Depending on the value of aforesaid characteristic autocorrelation time, two distinct market dynamics are introduced by the present invention: Coherent Market and Memoryless Market. Coherent Market is characterized with long autocorrelations or a long autocorrelation time. Memoryless Market is characterized with short autocorrelations or a short autocorrelation time. Memoryless Market with an infinitely short autocorrelation time is identified by the present invention as an Efficient Market. In other words, Memoryless Market is a market state identified by the Efficient Market Hypothesis (see above).

I-10. The concept of Coherent Market is a novel concept introduced by the present invention. Evaluating credit metrics, while taking into account the memory effect in stock price returns, is an innovative feature, which covers a wide spectrum of market behavior from coherent to memoryless markets.

### II. Related Art

II-1. The earliest default credit models were developed by Robert Merton [6] based on an algorithm known as the Black-Scholes option pricing algorithm [7] (Black-Scholes option pricing system based on Efficient Market Hypotheses [4]).

In Merton's model, a company's equity is treated as an option on the company's assets with a strike price equal to the face value of the company's debt. Merton's model applies an assumption of Geometric Brownian motion with a constant volatility for modeling the company's asset value. The company's asset value can be computed from a stochastic differential equation of the form of:

$$\frac{dV}{V} = μ dt + σ dW ( t ) , \qquad ( 1 )$$

Herein, V is the company's asset value which is simply a sum of the company's equity S and debt D, such that V=S+D, dV is a change in the asset value, μ is a drift of the company's asset value, σ is a volatility of the company's asset value, and W(t) is a standard Wiener process. The standard Wiener process is a Gaussian continuous time stochastic process with W(t=0)=0 and independent increments W(t)−W(s) with a mean 0 and a variance t−s for any time moments s and t, 0≤s<t.

The closed-form solution for the company's equity S in the Merton's model [6] is presented by the well-known Black-Scholes formulae [2]:

S=VN(d₁)−Dexp(r(T−t))N(d₂), (2)

\tilde{D}=VN(−d₁)+Dexp(−r(T−t))N(d₂), (3)

d₁=[ln(V/D)+(r+σ²/2)(T−t)]/σ\sqrt{(T−t)}, (4)

d₂=d₁−σ\sqrt{(T−t)}, (5)

wherein S is the company's equity, V is an asset value of the company, D is debt at maturity, that is the book value of the debt, which is due at maturity time T, \tilde{D} is current debt, that is a book value of the debt at time t, r is a risk free interest rate, T−t is time to maturity, N (d_{1,2}) is a cumulative normal probability distribution function defined as:

$$N ( {d}_{1 , 2} ) = \frac{1}{\sqrt{2 π}} {\int }_{- ∞}^{{d}_{1 , 2}} dw exp ( - \frac{{w}^{2}}{2} ) , \qquad ( 6 )$$

σ is a standard deviation of asset value of the company, which is inferred from the stock price of the company's equity S, the company's asset value V and the equity volatility σ_{S} by means of the following formula:

σ=(1/Δ)σ_{S}(S/V), (7)

wherein Δ is defined as follows: Δ=N(d₁).

It follows from formula (3) that the debt change is related to the company's asset value change by the formula:

$$d \tilde{D} = \frac{\partial \tilde{D}}{\partial V} dV = N ( - {d}_{1} ) dV . \qquad ( 8 )$$

Application of the Black-Scholes formulae (2)-(6) is different from the original Black-Scholes option pricing model [7], where values of V and its volatility a are plugged into the formula (2). In Merton's model [6], one can observe that stock price of a company's equity S and the equity volatility σ_{S} must infer the company's asset value V and the company's asset value volatility a.

The risk-neutral probability of the company's default in Merton's model [6] is

P_{default}^{Merton}=1−N(d₂)=N(−d₂), (9)

where N(d₂) is a probability of exercising the call option in the Black-Scholes model [7].

The distance between the company's asset value and the default point is called a distance to default. In Merton's structural model, the distance to default dd_{Merton}(T−t) is

dd_{Merton}(T−t)=d₂=[ln(V/D)+(r−σ²/2)]/σ\sqrt{(T−t)}. (10)

The company's credit spread s_{Merton} in Merton's model is

$${s}_{Merton} = - \frac{1}{T - t} ln \{ \frac{V}{D} N ( - {d}_{1} ) + exp ( - r ( T - t ) ) N ( {d}_{2} ) \} - r . \qquad ( 11 )$$

An expected credit loss (ECL) at maturity in the Merton's model ECL_{Merton} is

ECL_{Merton}=N(−d₂){D−Vexp(r(T−t))N(−d₁)/N(−d₂)}, (12)

which is expressed here as product of two terms. The first term N(d₂) is a probability of default P_{default}^{Merton}. The second term D−V exp(r(T−t))N(−d₁)/N(−d₂) is a loss when the default has occurred.

A company's recovery rate RR_{Merton} in Merton's model [6] is

$${RR}_{Merton} = \frac{{Ve}^{r ( T - t )}}{D} \frac{N ( - {d}_{1} )}{N ( - {d}_{2} )} , \qquad ( 13 )$$

The formulae (1)-(13) represent Merton's model [6] for calculating a probability of default, a distance to default, a credit spread, and a recovery rate of publicly traded companies. Merton's model is based on an assumption that a transition from a current financial state of a publicly traded company to a default state is governed by small changes in the company's financial state, that is by random walk.

Merton's model [6] is a memoryless market model. Merton's model [6] does not take into account random jumps of the company's equity frequently experienced in the modern market environment (see EMH above).

The algorithm described by formulae (1)-(10) has been commercially implemented, for example, by the Moody-KMV (e.g., see U.S. Pat. No. 6,078,903).

II-2. Jump-Diffusion Default Credit Models.

In 1974, Merton developed a jump-diffusion model [3] as an extension of the Black-Scholes model [7] for the option pricing valuation. Using a Merton-Black-Scholes framework, Zhou [23] developed a credit risk model using Merton's jump-diffusion model, which incorporates jump-diffusion behavior of the asset value of a company. According to this model, the dynamics of the asset value is described by a jump-diffusion process:

$$\frac{dV}{V} = ( μ - λ κ ) dr + σ dW ( t ) + ( {e}^{η} - 1 ) dY , \qquad ( 14 )$$

wherein V is an asset value of the company, μ, λ, and κ are positive constant, μ represents an expected return on the company's assets, dY is a Poisson process with an intensity parameter λ, η is a random jump amplitude which is a random normal variable with a mean ν and variance δ², and, finally, κ=exp(ν+δ²/2)+1.

A diffusion component σdW (t) in equation (14) characterizes the Brownian stochastic fluctuation of the company's asset value, related to changes in economic/market conditions, while a jump component (e^{η}−1)dY is relayed to shocking market events, which cause marginal changes of the company's value due to arrival of important negative company-specific information or macroeconomic catastrophic events. Because of the shocking market events, the market value of the company may drop down dramatically, and, therefore, can cause an event of default. In contrast to the Merton-KMV model, the asset value in equation (14) has a jump component, which may become the key driver for credit events.

In a jump-diffusion process, the jump component is related to specific shocking or catastrophic events in the market, such as, macroeconomic news, Fed's announcement, weather catastrophic events (hurricanes), and so on. The time-scale of the company's equity changes after the macroeconomic shock events varies in a large range from milliseconds passed from the booking order information into a trading system, to several days passed from the macroeconomic news. Moreover, the characteristic time of a stock price change depends on the type of market information. The stochastic motion of stock price of a public traded company is caused by competitive processes related to negative or positive information signals with specific characteristic times of the market response.

II-3. Empirical Evidence is an event impact that was presented by various scientific groups. The dependence of the asset return upon macroeconomic information was intensively investigated by Fisher in his work of the “theory of interest” [10]. The dependence of the asset return on macroeconomic information is also related to time-dependence functionality.

II-4. Fama and Schwert [11] investigated the relationship between a nominal interest rate and inflation using empirical linear regression and they showed that “the nominal real estate return moves in one-one correspondence with both the expected and unexpected components of the inflation rates”. Fama and Schwert concluded that the bond market was in complete hedge against expected inflation from linear regression tests with 1-6 monthly lagged periods. Adams et al. showed that large and medium-sized stocks tend to respond to Producer Price Index news in about 15 minutes.

II-5. Boyd, Hu and Jagannathan [12] applied an empirical fitting of the return against monthly lagged unemployment rates and growth rates of monthly industrial production to examine how stocks respond to unemployment news. Boyd, Hu and Jagannathan showed that stock prices rise during expansions and fall during contractions with bad labour market news.

II-6. Pattell and Wolfson [13], Greene and Watts [14], and Gosnell, Keown and Pinkerton [10] found that stock prices changed within an hour after company-specific news.

II-7. Lapp and Pearce [16] investigated the impact of economic news of monetary policy on stock price using linear regression fitting with one- and two-month lagged data. The high frequency trading algorithms apply information from displayed orders of the order book, orders' cancellations, and executions of the displayed orders.

II-8. Hasbrouck and Saar [17] reported observations of intraday dynamics of stock prices in a millisecond time-scale. The researchers investigated how high-frequency trading algorithms in general may harm or improve the market quality perceived by long-term investors. Their empirical analysis showed that, for some cases, a response time to trading information (from book orders) is comparable with a transmission time of a signal between the exchange trading system and brokers.

II-9. Remorov [19] showed that the time-scale of stock price changes after shocking events varies in a large range from milliseconds passed from the booking order information to several days passed from macroeconomic news, and, moreover, a characteristic time of the stock price change depends on the type of information.

Thus, it may be concluded that stochastic motion of the stock price is caused by competitive processes related to negative or positive information signals with specific probabilistic rates.

### BRIEF SUMMARY OF THE INVENTION

Daily stock return autocorrelation is one of the most visible stylized facts in empirical finance [20], [21].

One of the most visible stylized facts in empirical finance is autocorrelation of stock returns at fixed intervals (daily, weekly, monthly). This autocorrelation has presented a challenge to the main traditional models in continuous-time finance, which rely on some forms of the random walk hypothesis. Consequently, there is published extensive literature on stock return autocorrelation; it occupies four segments totaling 55 pages of Campbell, Lo, and MacKinlay (1997) [21]. The results presented in this literature were inconclusive; see the Literature Review in [20], Section 2.

The existing traditional models for calculation of credit risk metrics have the following drawbacks:

ignoring the presence of Memory Effect (herein also called ‘market memory impact’) in stock markets, which occurs through autocorrelation of stock price returns, empirically observed in the markets (see for example [20]);

and

ignoring the case (for example, in Zhou jump-diffusion credit risk models [23]), when an impact of the diffusion component of the asset value is comparable or even less than an impact of the jump component.

The present invention overcomes the aforesaid drawbacks by presenting the following embodiments.

A First Embodiment of the invention encompasses a Geometric Shot Noise Framework (GSNF) which incorporates the aforementioned market memory impact. The GSNF originally was developed by N. Laskin [18]. This is a unified framework that allows calculating values of different financial instruments. GSNT is applicable to memory, coherent and memoryless markets. GSNF utilizes an innovative approach for modeling behavior of a stock price as a superposition of high- and low-frequency price jumps, which is an alternative to the aforementioned Black-Scholes-Merton diffusion framework [6, 7] that applies to the memoryless market only. The First Embodiment is an implementation of GSNF as a computer based data processing system and method for valuation/calculation of credit risk metrics of publicly traded companies.

A Second Embodiment of the invention discloses a computer based data processing method for valuation/calculation of credit risk metrics of publicly traded companies, which method takes into account an impact of Memory Effect defined herein above. According to the Second Embodiment of present invention, application of the methodology of an exponential response function is implemented for modeling a stock price decline (exponential decreasing) after shocking events. In this regard, evaluating credit metrics taking into account the short/long-term memory effect in stock returns is an innovative feature, which covers a wide spectrum of market behavior from Coherent Market to Memoryless (efficient) Market.

A Third Embodiment of the invention discloses a computer-implemented method provided for calculation of the credit metrics of publicly traded companies. The Third Embodiment of present invention proposes an innovative structural credit risk model for calculation probabilities of the default, distance to default, credit spread, and recovery rate of publicly traded forms. This structural credit risk model incorporates both small amplitude high frequency changes and large amplitude low frequency jumps of the company's asset value observed in modern marketplace.

A Fourth Embodiment of the invention discloses a computer implemented method/system, incorporating a procedure to retrieve historical market data and calibrate them to obtain data for certain parameters required by the system's calculation module. The historical market data, which are subject to extraction and calibration, are:

r is a risk-free rate;
λ₁ is a mean of the number of jumps per unit time of the high frequency Geometric shot noise process involved into modeling company's asset value;
λ₂ is a mean of the number of jumps per unit time of the low frequency Geometric shot noise process involved into modeling company's asset value;
δ₁ is a variance of stock price jumps amplitude of the high frequency Geometric shot noise process involved into modeling company's asset value;
δ₂ is a variance of stock price jumps amplitude of the low frequency Geometric shot noise process involved into modeling company's asset value;
α is a memory parameter of the high frequency Geometric shot noise process involved into modeling company's asset value, herein further also called an inverse characteristic time of the stock price decline under impact of the high frequency shot noise;
β is a memory parameter of the low frequency Geometric shot noise process involved into modeling company's asset value, herein further also called an inverse characteristic time of the stock price decline under impact of the low frequency shot noise.

### BRIEF DESCRIPTION OF DRAWINGS OF THE INVENTION

These and other objects, features and advantages of the invention will be apparent from a consideration of the following detailed description of the invention when read in conjunction with drawing figures, in which:

FIG. 1 is a plot showing the dependence of a probability of default upon an asset value of a company, wherein: debt of the company is 15, maturity of debt is 1, volatility is 0.1, risk-free rate is 0.01, and wherein the probability of default is calculated based on Formula (33) for a stochastic diffusion process without jumps shown with filled-in triangles and a stochastic diffusion process with jumps with parameters λ=10, β=0.07, β=50 shown with filled-in squares.

FIG. 2 is a plot showing the dependence of a credit spread on the asset value of a company, wherein debt of the company is 15, maturity of debt is 1, volatility is 0.1, risk-free rate is 0.01; stochastic diffusion process without jumps shown with filled-in triangles and stochastic diffusion process with jumps with parameters λ=10, β=0.07, β=50 shown with filled-in squares.

FIG. 3 is a plot showing the dependence of stock price upon day time for Memory Market illustrating its behavior (a stock price intraday chart of Citigroup® during May 12, 2016). The stock price of Citigroup® dropped during the day caused by the possible impact from negative news.

FIG. 4 is a plot showing the dependence of stock price upon day time for Coherent Market illustrating its behavior (a stock price intraday chart of Tatneft′PAO®). The stock has a low liquidity while the correlation time is large. This is a typical jump-like pattern of stock price, when the classical Black-Scholes model with involvement of the continuous Wiener process is not applicable.

FIG. 5 is a plot showing the dependence of stock price upon 3-day time for Memoryless Market illustrating its behavior (a stock price intraday chart of Manulife Financial)). The correlation time is infinitely small, that is the market state identified by the Efficient Market Hypothesis (EMH).

### DETAILED DESCRIPTION OF PREFERRED EMBODIMENTS OF THE INVENTION

First Embodiment of the invention assumes that the company's asset value is followed by superposition of two Geometric Shot noise processes, which is a reasonable assumption for real financial markets driven by jump-like information processes.

An asset dynamic model of the two Geometric Shot noise processes incorporates observed market prices patterns including superposition of—high frequency small magnitude random jumps of stock prices and—low frequency large magnitude random jumps of stock prices. Each of the two independent Geometrical Shot noise processes is characterized by its jumps frequency, by statistical properties of its elementary jump and memory parameters.

Shot-Noise Random Process

Shot Noise is the well-known stochastic process that is applied for modeling stochastic phenomena in many different fields of science.

A shot-noise process F(t) is described by the following formula [22]:

$$F ( t ) = {\sum }_{k = 1}^{n} {η}_{k} ϕ ( t - {t}_{k} ) , \qquad ( 15 )$$

wherein random jumps magnitudes ηₖ are statistically independent and distributed with a probability density p(η), random points tₖ are homogeneously distributed on a time interval [t,T], so that their number n obeys Poisson's law, and deterministic function φ(t) is the response (or memory) function (φ(t)=0 for t<0). The shot-noise process F(t) describes an impact of different fluctuating market factors on the company's asset value V.

A single-shot-noise pulse ηₖ (t−tₖ) describes an impact of information available at a random moment tₖ on the stock price at a later time t. The random jump amplitude ηₖ responds to the magnitude of the pulse φ(t−tₖ). The jump amplitude ηₖ depends on the type of information and therefore, it will be a random variable subjected to the distribution with the probability density p(η). For simplicity of consideration, it can be assumed that each pulse has the same functional form, i.e. the response function φ(t) describes the shot-pulse dynamics with the “memory” impact as the response factor from the shocking events.

Response Function.

In Second Embodiment of the invention, the memory impacts are modeled by an exponential response function. The short/long-term memory effects of stock price return are described by characteristic times of the stock price decline through an exponential decay after specific shocking events, (see, FIG. 3). The presence of the short/long-term memory effects in stock returns has important implications for the valuation of financial instruments and it has a substantial impact on credit risk metrics of publicly traded forms. For example, option pricing valuation becomes extremely sensitive to the investment period, where the stock price returns have a long-range time dependency.

The present invention contemplates an implementation of the exponential response function with finite memory, which has a form of an exponential distribution [22]:

φ(t)=α exp(−αt), (16)

wherein α is the impact factor defined as an inverse characteristic time of the stock price decline, which describes an impact of the market's memory on the stock price stochastic behavior. The impact factor is analogue of the impact rate or the rate of reaction in physical and chemical processes. The new approach with application of random processes with finite memory allows one modeling and evaluating the credit events in the current complex and vulnerable economic environment.

Company's Equity as European Option Value.

First Embodiment of the present invention encompasses a method for calculation of credit risk metrics based on the assumption that two random processes can simultaneously trigger default of the company. The two random processes are characterized by two independent Geometrical Shot noise processes, for which elementary jump behaviors differ by frequency, jump magnitudes, and market memory impacts [18, 22].

Similarly to Merton's model [6], Laskin's model [18] treats a company's equity as an option on the company's assets with a strike price equal to the face value of the company's debt. Laskin's model applies an assumption of Geometric Shot noise processes for modeling the company's asset value. The model incorporates the memory impact on the company's stock price return. The memory impact is initiated by micro/macro-economic, social, political and catastrophic events and it is modeled by means of a response function. The First Embodiment assumes that a company's asset value is expressed by a stochastic differential equation of the following form:

$$\frac{dV}{V} = {F}_{1} ( t ) dt + {F}_{2} ( t ) dt , \qquad ( 17 )$$

wherein V is the asset value of the company, dV is a change in asset value, F₁(t), F₂(t) (high frequency F₁(t) and low frequency F₂(t) shot noises) are two independent of each other shot-noise processes, described by the following formula:

$${F}_{1 , 2} ( t ) = {\sum }_{k = 1}^{n} {η}_{1 , 2}^{( k )} {ϕ}_{1 , 2} ( t - {t}_{1 , 2 ( k )} ) , \qquad ( 18 )$$

wherein random jumps magnitudes η_{1,2}^{(k)} are statistically independent and distributed with a probability densities p_{1,2}(η) respectively, random points t_{1,2(k)} are homogeneously distributed on a time interval [t,T], so that their numbers n_{1,2} obeys Poisson's law with parameters λ₁ and λ₂, which are frequencies of jumps involved into the two shot noises F₁(t) and F₂(t) respectively, and, finally, two deterministic functions φ_{1,2}(t) are the response (or memory) functions (φ_{1,2}(t)=0 for t<0). The superposition of the two shot noises significantly enhances the ability of the model describe observed on market patterns of companies asset values changes. It is assumed that λ₁>>λ₂ or, in other words, that F₁(t) is a high frequency shot noise and F₂(t) is a low frequency shot noise.

The new stochastic differential equation (17) describes both and high- and low-frequency jumps in stochastic behavior of the company's asset value with specific jump parameters, including the memory effects. The stochastic differential equation (17) presents a fundamental background for the main double jump mode (a sum of the high- and low-frequency jumps) of the inventive method and system.

By analogy with the traditional Merton's structural model, in Laskin's model a company may default if its asset value becomes less than a specific asset level or default barrier level. The default barrier level can be defined from a short and long term liability or as specific level defined by an investor. If the asset value of a company falls below a default barrier level at the bond's maturity, V(T)<D, then the company cannot repay its bondholders and the company defaults.

The inventive analytical solution for company's equity S in the double jump mode is presented by formulas (19)-(27), which are displayed below:

$$\{ \begin{matrix}S = {VL}_{1} ( l ) - D exp ( - r ( T - t ) ) {L}_{2} ( l ) \\ \sqrt{{λ}_{1 S}} \cdot {δ}_{1 S} S = {L}_{1} ( l ) \sqrt{{λ}_{1 }} \cdot {δ}_{1} V \\ \sqrt{{λ}_{2 S}} \cdot {δ}_{2 S} S = {L}_{2} ( l ) \sqrt{{λ}_{2 }} \cdot {δ}_{2} V\end{matrix} , \qquad ( 19 )$$

wherein: D is a book value of debt due at a maturity time T, r is a risk free interest rate, T−t is time to maturity, L₁(l) and L₂(l) are functions defined by the following formulas:

$$\begin{matrix}{L}_{1} ( l ) = \frac{1}{2 π} exp \{ - {\int }_{0}^{T - t} ( {λ}_{1} {ς}_{{m}_{1}} ( τ ) + {λ}_{2} {ς}_{{m}_{2}} ( τ ) ) d τ \} {\int }_{- ∞}^{l} dz {\int }_{- ∞}^{∞} {dke}^{ikz - z} exp \{ - {\int }_{0}^{T - t} ( {λ}_{1} {ξ}_{{m}_{1}} ( k , τ ) + {λ}_{2} {ξ}_{{m}_{2 }} ( k , τ ) ) d τ \} , \\ and & ( 20 ) \\ {L}_{2} ( l ) = \frac{1}{2 π} {\int }_{- ∞}^{l} dz {\int }_{- ∞}^{∞} {dke}^{ikz} exp \{ - {\int }_{0}^{T - t} ( {λ}_{1} {ξ}_{{m}_{1}} ( k , τ ) + {λ}_{2} {ξ}_{{m}_{2}} ( k , τ ) ) d τ \} , & ( 21 )\end{matrix}$$

with the assumption of λ_{1,2}≅λ_{1,2S}, which is reasonable assumption in efficient market environment, since information of the shocking event is effectively distributed (propagated) among all participants of the market; hence, jumps of frequency of the company's asset value will initiate approximately the same frequency of the company stock price jumps.
Further, l is defined as follows:

$$l = ln \frac{V}{D} + r ( T - t ) - {\int }_{0}^{T - t} ( {λ}_{1} {ϛ}_{{m}_{1}} ( τ ) + {λ}_{2} {ϛ}_{{m}_{2}} ( τ ) ) d τ , \qquad ( 22 )$$

with four functions ζₘ_{_{1,2}}(τ) and ξₘ_{_{1,2}}(k) calculated as:

$$\begin{matrix}{ϛ}_{{m}_{1 , 2}} ( τ ) = {\int }_{- ∞}^{∞} d η {p}_{1 , 2} ( η ) ( {e}^{η {m}_{1 , 2}} - 1 ) , & ( 23 ) \\ {ξ}_{{m}_{1 , 2}} ( k ) = {\int }_{- ∞}^{∞} d η {p}_{1 , 2} ( η ) ( {e}^{ik η {m}_{1 , 2} ( τ )} - 1 ) , & ( 24 )\end{matrix}$$

wherein said four functions ζₘ_{_{1,2}}(τ) and ξₘ_{_{1,2}}(k) include two memory functions:

m₁(t)=1−exp(−αt), (25)

and

m₂(t)=1−exp(−βt), (26)

wherein α is an inverse characteristic time of a stock price decline under impact of the high frequency shot noise F₁(t); and β is an inverse characteristic time of the stock price decline under impact of the low frequency shot noise F₂(t) p_{1,2}(η) are two probability density functions defined as:

$${p}_{1 , 2} ( η ) = \frac{1}{\sqrt{2 {πδ}_{1 , 2}^{2}}} exp \{ - \frac{{( η - {v}_{1 , 2} )}^{2}}{2 {δ}_{1 , 2}^{2}} \} , \qquad ( 27 )$$

wherein:
ν_{1,2} are means of the random magnitudes of said random jumps;
δ_{1,2} are variances of the random magnitudes of said random jumps.

In contrast to Merton's credit model [6] that considers only continuous changes in price movements, the present invention introduces a model, which in addition to its main double jump mode has a jump-diffusion mode. In the jump-diffusion mode, the inventive model takes into consideration both continuous (diffusion) and discontinues (jumps) changes of the company's asset value. The inventive analytical solution for the company's equity S in the jump diffusion mode is presented by formulas (28)-(38), which are displayed below:

$$\{ \begin{matrix}S = {VL}_{1} ( {l}_{diff} ) - D exp ( - r ( T - t ) ) {L}_{2} ( {l}_{diff} ) \\ \sqrt{{λ}_{S}} \cdot {δ}_{S} S = {L}_{1} ( {l}_{diff} ) \sqrt{λ} \cdot δ V \\ {σ}_{S} S = {L}_{2} ( {l}_{diff} ) σ V ,\end{matrix} \qquad ( 28 )$$

wherein D is debt at maturity time T, r is a risk free interest rate, T−t is time to maturity, the functions L₁(l_{diff}) and L₂(l_{diff}) are calculated using the following equations:

$$\begin{matrix}{L}_{1} ( l ) {}_{diff} {L}_{1} ( {l}_{diff} ) = \frac{1}{2 π} exp \{ - \frac{{σ}_{α}^{2} ( T - t )}{2} - {\int }_{0}^{T - t} {λ}_{2} {ϛ}_{{m}_{2}} ( τ ) d τ \} \times {\int }_{- ∞}^{{l}_{diff}} dz {\int }_{- ∞}^{∞} {dke}^{ikz - z} exp \{ - \frac{{σ}_{α}^{2} {k}^{2} ( T - t )}{2} - {\int }_{0}^{T - t} {λ}_{2} {ξ}_{{m}_{2}} ( k , τ ) d τ \} , & ( 29 ) \\ and & \\ {L}_{1} ( l ) {}_{diff} {L}_{2} ( {l}_{diff} ) = \frac{1}{2 π} exp \{ - \frac{{σ}_{α}^{2} ( T - t )}{2} - {\int }_{0}^{T - t} {λ}_{2} {ϛ}_{{m}_{2}} ( τ ) d τ \} \times {\int }_{- ∞}^{{l}_{diff}} dz {\int }_{- ∞}^{∞} {dke}^{ikz} exp \{ - \frac{{σ}_{α}^{2} {k}^{2} ( T - t )}{2} - {\int }_{0}^{T - t} {λ}_{2} {ξ}_{{m}_{2}} ( k , τ ) d τ \} , & ( 30 )\end{matrix}$$

where parameter l_{diff} is defined by

$${l}_{diff} = ln \frac{V}{D} + ( r - \frac{{σ}_{α}^{2}}{2} ) ( T - t ) - {\int }_{0}^{T - t} ( {λ}_{2} {ϛ}_{{m}_{2}} ( τ ) ) d τ , \qquad ( 31 )$$

with σ_{α}² defined by

σ_{α}²=σ²b_{T-t}^{α}, (32)

wherein σ is a standard deviation of said asset value V, calculated by the following formula:

σ=(1/Δ)σ_{S}(S/V), (33)

and wherein Δ defined is calculated as Δ=N(d₁^{α}), where

$$\begin{matrix}N ( {d}_{1}^{ α} ) = \frac{1}{\sqrt{2 π}} {\int }_{- ∞}^{{d}_{1}^{ α}} dw exp ( - \frac{{w}^{2}}{2} ) , & ( 34 ) \\ where & \\ {d}_{1}^{ α} = [ ln ( V \text{/} D ) + ( r + {σ}^{2} {b}_{T - t}^{α} \text{/} 2 ) ( T - t ) ] \text{/} σ \sqrt{{b}_{T - t}^{α} ( T - t )} , & ( 35 ) \\ and & \\ {b}_{T - t}^{α} = 1 - 2 ( \frac{{e}^{- 2 α ( T - t )} - 1}{4 α ( T - t )} - \frac{{e}^{- α ( T - t )} - 1}{α ( T - t )} ) , & ( 36 )\end{matrix}$$

wherein α is an inverse characteristic time of the stock price decline under impact of the high frequency shot noise F₁(t); and function ζₘ_{₂}(τ) is defined by the following formulae:

$${ϛ}_{{m}_{2}} ( τ ) = {\int }_{- ∞}^{∞} d η {p}_{2} ( η ) ( {e}^{η {m}_{2} ( τ )} - 1 ) , \qquad ( 37 )$$

p₂(η) is a probability density function defined as:

$${p}_{2} ( η ) = \frac{1}{\sqrt{2 {πδ}_{2}^{2}}} exp \{ - \frac{{( η - {v}_{2} )}^{2}}{2 {δ}_{2}^{2}} \} , \qquad ( 38 )$$

wherein ν₂ is a mean of the random magnitudes of said random jumps; δ₂ is a variance of the random magnitudes of said of random jumps; and a memory function m₂(t) is defined by equation (26).

This inventive feature is achieved by implementing a diffusion approximation method to approximate the high frequency shot noise F₁(t), while keeping the low frequency shot noise F₂(t) in its original format. The diffusion approximation method for F₁(t) is a special case when the mean of magnitude of asset price jumps ν₁→0, the variance of magnitude of the asset price jumps δ₁²→0 and the arrival rate of asset price jumps λ₁→∞ while the products λ₁ν₁ and λ₁δ₁² remain finite. In the diffusion approximation method, functions L₁(l) and L₂(l) defined by equations (20) and (21) are transformed into functions L₁(l_{diff}) and L₂(l_{diff}) defined by equations (30) and (31).

In addition to the double jump mode and jump diffusion mode, the model contemplated by the present invention introduces a diffusion mode. In the diffusion mode, only continuous (diffusion) movements of a company's asset value are considered. The inventive analytical solution for the company's equity S in the diffusion mode is presented by formulas (39)-(43), which are displayed below:

S=VN(d₁^{α})−Dexp(−r(T−t))N(d₂^{α}), (39)

wherein N(d_{1,2}^{α}) is a normal cumulative probability distribution function calculated as

$$N ( {d}_{1 , 2}^{ α} ) = \frac{1}{\sqrt{2 π}} {\int }_{- ∞}^{{d}_{1 , 2}^{ α}} dw exp ( - \frac{{w}^{2}}{2} ) , \qquad ( 40 )$$

wherein d₁^{α} is presented by the formula (35) and d₂^{α} is presented by the following formula:

d₂^{α}=[ln(V/D)+(r−σ²b_{T-t}^{α}/2)(T−t)]/σ\sqrt{b_{T-t}^{α}(T−t)}, (41)

wherein D is debt at maturity time T, r is a risk free interest rate, T−t is time to maturity, σ is a standard deviation of said asset value V, calculated by the following formula:

σ=(1/Δ)σ_{S}(S/V), (42)

and wherein Δ is calculated as Δ=N(d₁^{α}), and b_{T-t}^{α} is calculated as:

$${b}_{T - t}^{α} = 1 - 2 ( \frac{{e}^{- 2 α ( T - t )} - 1}{4 α ( T - t )} - \frac{{e}^{- α ( T - t )} - 1}{α ( T - t )} ) , \qquad ( 43 )$$

and wherein α is an inverse characteristic time of the stock price decline under impact of the high frequency shot noise F₁(t).

The market memory impact factor is analogue to an impact rate or a rate of reaction in physical and chemical processes. The new approach with application of a random process with finite market memory is well suitable for modeling and evaluating credit metrics of publicly traded companied in the current complex and vulnerable economic environment. The exponential form of the response function results in the memory function, expressed in the equation (16) above.

Third Embodiment of the present invention discloses a procedure for retrieving historical market data and calibrating them to obtain data for the parameters required for the system's calculation module. The historical market data, which are subject to extraction, are:

r is a risk-free rate;
λ_{1,2} are two means of a number of jumps per unit time of the company asset value;
δ_{1,2} is a variance of the asset value jumps magnitude;
α is an inverse characteristic time of the asset value decline under a high frequency Shot Noise impact;
β is an inverse characteristic time of the asset value decline under a low frequency Shot Noise impact.

The historical market data for λ_{1,2}, δ_{1,2}, α, and β are subject to a calibration process. The purpose of the calibration process is to transform the market data aiming to prepare them in a format acceptable by the evaluation module of the inventive system.

Calibration Methods.

Two calibration methods are disclosed herein for calibration of market parameters, which are used in the present invention.

In a First Calibration Method, the model parameters λ_{1,2}, δ_{1,2}, α, and β are calibrated straightforwardly from historical data of the stock prices data. The First Calibration Method technique is based on an assumption that the asset value Vis governed by the logarithmic stochastic differential equation (log SDE), equation (17).

In a Second Calibration Method, the model parameters λ_{1,2}, δ_{1,2}, α, and β are calibrated using the option pricing formula (19). To calculate the market parameters, an inverse problem of determining the model parameters is solved based on an analytical solution for the European option pricing formula (see, the first formula in equations (19)) originally found in [18].

Credit Metrics of Publicly Traded Companies.

Credit Metrics—Probability of Default and Distance to Default in a double-jump mode (see definition below).

The risk-neutral probability of the company's default in the double-jump mode is defined as follows:

P_{default}1−L₂(l), (44)

with L₂(l) being the probability of exercising a call option (21) in Laskin's model [18].

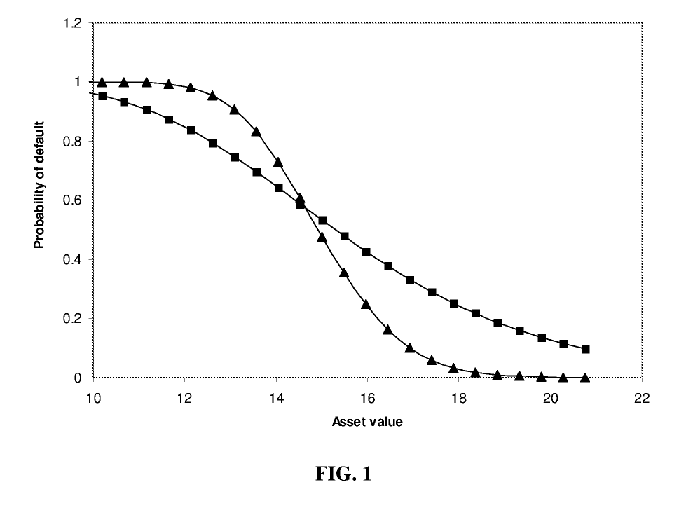

FIG. 1 shows an example of dependence of probability of default upon asset value of a company calculated from equation (44). For FIG. 1, debt of the company is 15, maturity of debt is 1, volatility 0.1, risk-free rate is 0.01. The probability of default is calculated from formula (44) for a stochastic diffusion process without jumps (shown with filled-in triangles in FIG. 1) and stochastic diffusion process with jumps with parameters λ=10, δ=0.07, β=50 (shown with filled-in squares in FIG. 1).

The distance between the company's asset value and default point is also called a Distance to Default. In Laskin's model the distance to default dd(T−t), in the double-jump mode is defined as follows:

$$dd ( T - t ) = l = ln \frac{V}{D} + r ( T - t ) - {\int }_{0}^{T - t} ( {λ}_{1} {ϛ}_{{m}_{1}} ( τ ) + {λ}_{2} {Ϛ}_{{m}_{2}} ( τ ) ) d τ . \qquad ( 45 )$$

Credit Metric—Credit Spread in Double-Jump Mode.

A company's credit spread s in Laskin's model in the double-jump mode is defined as follows:

$$s = - \frac{1}{T - t} ln \{ \frac{V}{D} ( 1 - {L}_{1} ( l ) ) + exp ( - r ( T - t ) ) {L}_{2} ( l ) \} - r . \qquad ( 46 )$$

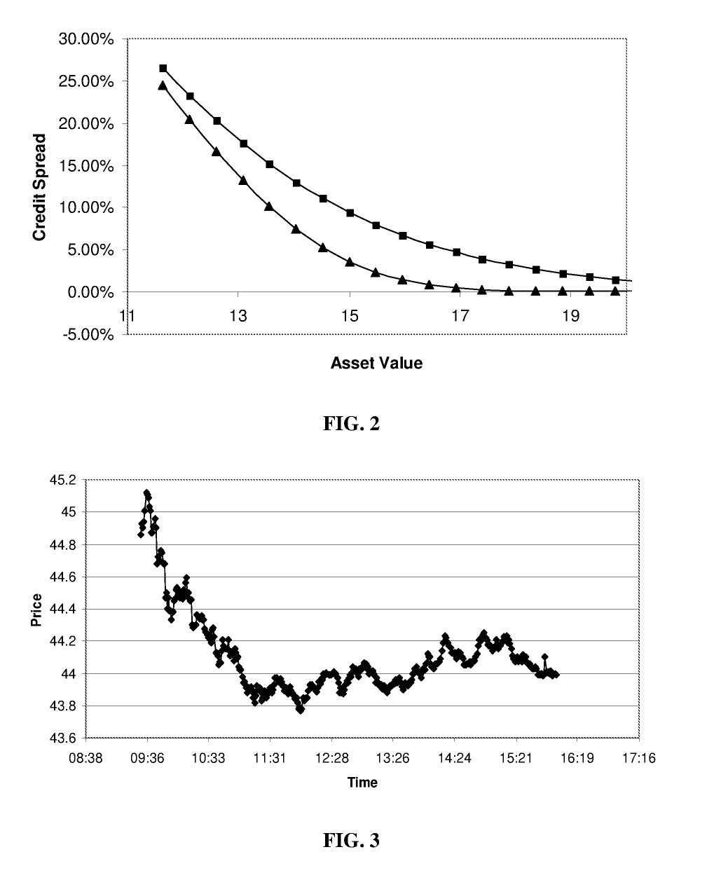

FIG. 2 shows an example of a dependence of credit spread upon asset value of the company. In FIG. 2, debt of the company is 15, maturity of debt is 1, volatility is 0.1, risk-free rate is 0.01. A stochastic diffusion process without jumps is shown with filled-in triangles in FIG. 2; and a stochastic diffusion process with jumps having parameters λ=10, δ=0.07, β=50 is shown with filled-in squares in FIG. 2.

Credit Metric—Expected Credit Loss (ECL) in the Double-Jump Mode.

An expected credit loss at maturity in Laskin's model in the double-jump mode is defined as follows:

ECL=(1−L₂(l)){D−Vexp(r(T−t))L₁(l)/L₂(l)}, (47)

which is expressed here as a product of two terms. The first term (1−L₂(l)) is a probability of default P_{default} The second term D−V exp(r(T−t))L₁(l)/L₂(l) is a loss when default has been occurred.

Credit Metric—Recovery Rate (RR) in the Double-Jump Mode.

A company's recovery rate RR in Laskin's model in the double-jump mode is defined as follows:

$$RR = \frac{V {e}^{r ( T - t )}}{D} \frac{{L}_{1} ( l )}{{L}_{2} ( l )} . \qquad ( 48 )$$

Credit Metrics—Probability of Default and Distance to Default in a jump-diffusion mode (see definition below). The risk-neutral probability of the company's default in the jump-diffusion mode is defined as follows:

P_{default}=1−L₂(l_{diff}). (49)

with L₂(l_{diff}) being the probability of exercising a call option (20) in the jump-diffusion mode.

The distance between the company's asset value and the default point is also called a Distance to Default. In Laskin's model the distance to default dd(T−t) in the jump-diffusion mode is defined as follows:

$$dd ( T - t ) = l = ln \frac{V}{D} + ( r - \frac{{σ}_{α}^{2}}{2} ) ( T - t ) - {\int }_{0}^{T - t} {λ}_{2} {ϛ}_{{m}_{2}} ( τ ) d τ . \qquad ( 50 )$$

Credit Metric—Credit Spread in the Jump-Diffusion Mode.

A company's credit spread s in Laskin's model in the jump-diffusion mode is defined as follows:

$$s = - \frac{1}{T - t} \{ ln \{ {L}_{2} ( {l}_{diff} ) + \frac{V}{D} exp ( r ( T - t ) ) ( 1 - {L}_{2} ( {l}_{diff} ) ) \} - r . \qquad ( 51 )$$

Credit Metric—Expected Credit Loss (ECL) in the Jump-Diffusion Mode.

An expected credit loss at maturity in Laskin's model in the jump-diffusion mode is defined as follows:

ECL=(1−L₂(l_{diff}){D−Vexp(r(T−t))L₁(l_{diff})/L₂(l_{diff})}. (52)

which is expressed here as a product of two terms. The first term (1−L₂(l_{diff}) is a probability of default P_{default}. The second term D−V exp(r(T−t))L₁(l_{diff})/L₂(l_{diff}) is a loss when default has been occurred.

Credit Metric—Recovery Rate (RR) in the jump-diffusion mode. A company's recovery rate RR in Laskin's model in the jump-diffusion mode is defined as follows:

$$RR = \frac{{Ve}^{r ( T - t )}}{D} \frac{{L}_{1} ( {l}_{diff} )}{{L}_{2} ( {l}_{diff} )} . \qquad ( 53 )$$

Credit Metrics—Probability of Default and Distance to Default in a diffusion mode (see definition below). The risk-neutral probability of the company's default in the diffusion mode is defined as follows:

P_{default}=1−N(d₂^{α}). (54)

The distance between the company's asset value and the default point is also called a Distance to Default. In Laskin's model the distance to default dd(T−t) in the diffusion mode is defined as follows:

$$dd ( T - t ) = l = ln \frac{V}{D} + ( r - \frac{{σ}^{2} {b}_{T - 1}^{α}}{2} ) ( T - t ) . \qquad ( 55 )$$

Credit Metric—Credit Spread in the Diffusion Mode.

A company's credit spread s in Laskin's model in the diffusion mode is defined as follows:

$$s = - \frac{1}{T - t} ln \{ N ( {d}_{2}^{α} ) + \frac{V}{D} exp ( r ( T - t ) ) ( 1 - N ( {d}_{2}^{α} ) ) \} - r . \qquad ( 56 )$$

Credit Metric—Expected Credit Loss (ECL) in the Diffusion Mode.

An expected credit loss at maturity in Laskin's model in the diffusion mode is defined as follows:

ECL=N(−d₂^{α}){D−Vexp(r(T−t))N(−d₁^{α})/N(−d₂^{α})}. (57)

which is expressed here as a product of two terms. The first term N(−d₂^{α}) is a probability of default P_{default} The second term D−V exp(r(T−t))N(−d₁^{α})/N(−d₂^{α}) is a loss when default has been occurred.

Credit Metric—Recovery Rate (RR) in the diffusion mode. A company's recovery rate RR in Laskin's model in the diffusion mode is defined as follows:

$$R = \frac{{Ve}^{r ( T - t )}}{D} \frac{N ( - {d}_{1}^{α} )}{N ( - {d}_{2}^{α} )} . \qquad ( 58 )$$

System's Operational Modes.

The credit risk structural model presented by this invention covers in a unified consistent manner both continuous Gaussian random walks and non-Gaussian discontinuous random jumps observed in the current stock market behavior. Closed form formulas of the credit risk metrics are implemented as a computer-aided data processing method. The credit risk structural model disclosed herein and expressed by exact analytical formulae is an innovative double jump structural credit risk model with a memory impact.

Normally, a main operational mode of the inventive credit risk structural model is a double jump operational mode with Market Memory Impact. In addition to the double jump operational mode, the inventive model can work in a jump-diffusion operational mode and in a diffusion operational mode. Each of the above listed modes has two operational sub-modes:—a sub-mode with Long Market Memory Impact—Coherent Market and—Short Market Memory Impact—a Memoryless Market sub-mode.

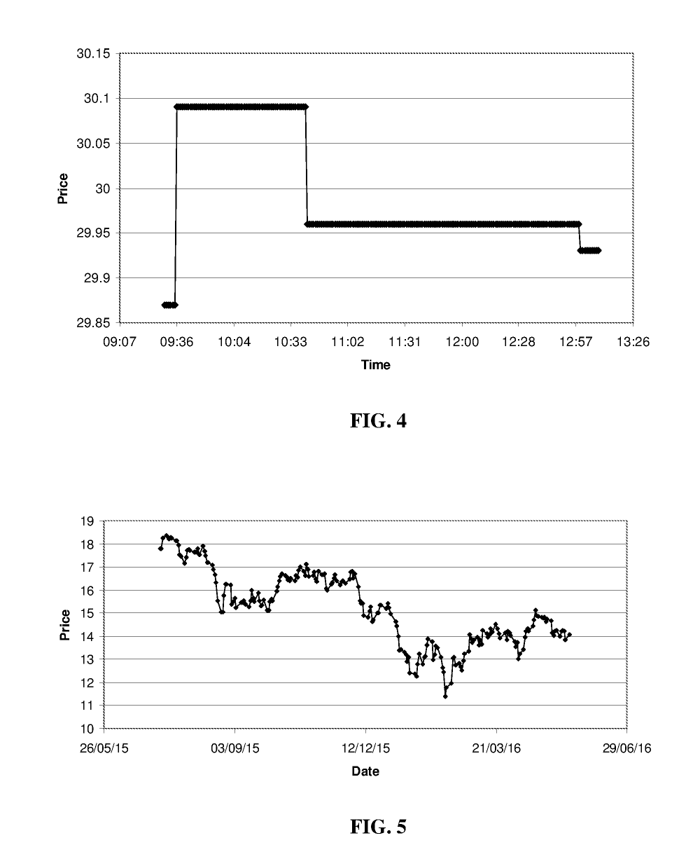

As noted above, Market Memory Impact is illustrated by FIG. 3. Coherent Market's behavior is illustrated by FIG. 4. Memoryless Market behavior is illustrated by FIG. 5.

i. Main Operational Mode.

The main operational mode of the inventive model is a double jump mode with market memory impact.

In this mode, stock price jumps of a high frequency small magnitude and a low frequency large magnitude are involved for calculation of the credit risk metrics of publicly traded companies. This mode is well suitable to a model observed in modern market patterns of prices of asset values where large magnitude jumps are outliers on the background of small magnitude price jumps. The credit risk metrics in the main operational mode are calculated based on formulae (44)-(48).

ii. Jump Diffusion Operational Mode.

Another operational mode is a jump-diffusion mode with a market memory impact caused by the stock market.

This mode is applicable to markets, where an asset price pattern displays jumps, occurring at the background of a high frequency and small magnitude asset price fluctuations. The Jump Diffusion Operational Mode is modeled by superposition of two shot noise processes F₁(t) and F₂(t). While F₂(t) describes jumps, F₁(t) is taken in diffusion approximation to describe a small magnitude stock price fluctuations. The diffusion approximation for F₁(t) is a special case when the mean of magnitude of asset price jumps ν₁→0, the variance of magnitude of asset price jumps δ₁²→0 and the arrival rate of asset price jumps λ₁→∞ while the products λ₁ν₁ and λ₁δ₁² remain finite. In the jump-diffusion mode the functions L₁(l) and L₂(l) defined by equations (20) and (21) are transformed into functions L₁(l_{diff}) and L₁(l_{diff}) defined by equations (29) and (30).

In the jump-diffusion mode both continuous and discontinues large price jumps are involved for calculation of the credit risk metrics of publicly traded companies. This operational mode is well suited for markets with a jump-diffusion information flow manifestation of which is asset price jumps, occurring at the background of a high frequency and a small magnitude of asset price fluctuations.

The credit risk metrics in the jump-diffusion operational mode are calculated based on formulae (49)-(53).

iii. Diffusion Operational Mode.

The diffusion operational mode is a pure diffusion mode with a market memory impact caused by the stock market.

In this mode, only continues small movements (random walks) of the stock price are involved for calculation of the credit metrics of publicly traded companies. The credit risk metrics in the diffusion operational mode are calculated based on formulae (54)-(58).

The diffusion operational mode is designed to operate when stock prices display continuous random walks patterns (see, FIG. 9). In the diffusion operational mode, the Memoryless Market sub-model replicates the results of the traditional Merton's model [6].

The credit risk metrics in the traditional Merton's model are calculated based on formulae (9)-(13). The credit risk metrics system in the traditional Merton's model has been implemented by KMV (see, U.S. Pat. No. 6,078,903).

### REFERENCES

1. Weisstein, Eric W. “Wiener Process.” FromMathWorld—Wolfram Web Resource. http://mathworld.wolfram.com/WienerProcess.html.
2. Frank A. Haight, Handbook of the Poisson Distribution.: (John Wiley & Sons, New Fork, 1967).
3. Eric W. Weisstein, Poisson Process. FromMathWorld—A Wolfram Web Resource. http://mathworld.wolfram.com/PoissonProcess.html).
4. Peter Crosbie, (2003), Modeling default Risk, Modeling methodology, Moody's KMV.
5. Moody-KMV, U.S. Pat. No. 6,078,903.
6. R. Merton, (1974), On the pricing of corporate debt: The risk structure of interest rates, Journal of Finance, 29: 449-470.
7. F. Black & M. Scholes, (1973), The pricing of options and corporate liabilities, Journal of Political Economy, 7 (637-654).
8. R. Merton, (1976), Option pricing when underlying stock returns are discontinuous, Journal of Finance, 29, 449-470.
9. E. Fama, (1970), Efficient Capital. Markets: A Review of Theory and Empirical Work, Journal of Finance 25 (2), 383-417.
10. I. Fisher, The Theory of Interest, (Pickering &Chatto, 1997), 612 pages.
11. E. Fama, G. Schwert, (1977), Asset returns and Inflation, Journal of Financial Economics, 5, 115-145.
12. J. H. Boyd, J. Hu, R. Jagannathan, (2005), The Stock Market's Reaction to Unemployment News: Why Bad News is Usually Good for Stocks. The Journal of Finance, 60, 649-672.
13. J. Patell, M. Wolfson, (1984), The Intraday Speed of Adjustment of Stock Prices to Earning and Dividend Announcements, Journal of Financial Economics, 13, 223-252.
14. J. Greene, and S. Watts, (1996), $Price Discovery on the NYSE and the NASDAQ: The Case of Overnight and Daytime News Releases, Financial Management, 25, 649-672.
15. T. Gosnell, A. Keown, and J. Pinkerton, (1996), The Intraday Speed of Stock Price Adjustment to Major Dividend Changes: Bid-ask Bounce and Order Flow Imbalances, Journal of Banking and Finance, 20, 247-266.
16. J. S. Lapp, D. K. Pearce, (2012), The Impact of Economic News on Expected Changes in Monetary Policy, Journal of Macroeconomics, 34, 362-379.
17. J. Hasbrouck, G. Saar, (2013), Low-latency trading, Journal of Financial Markets, 16, 646-679.
18. N. Laskin, (2014), New Pricing Framework: Options and Bonds, e-print, http://arxiv.org/abs/1407.4452.
19. R. Remorov, (2014), Panic Indicator for Measurements of Pessimistic Sentiments from Business News, International Business Research, 7, 103-111.
20. Robert M. Anderson, Kyong ShikEomb, Sang BuhmHahn, Jong-Ho Park, Sources of stock return autocorrelation, Working paper available on-line at http://eml.berkeley.edu/˜anderson/Sources-042212.pdf, 63 pages.
21. John Y. Campbell, Andrew W. Lo, & A. Craig MacKinlay, The Econometrics of Financial Markets, (Princeton University Press 1997), 632 pp.
22. N. Laskin, (2000), Fractional market dynamics, Physica A, 287, 482-492.
23. Zhou, Chunsheng, (1997), A Jump-Diffusion Approach to Modeling Credit Risk and Valuing Defaultable Securities, Research Paper; Internet, Federal Reserve Board (Washington, D.C.), 1-47.
24. W. H. Press, S. A., Teukolsky, W. T. Vetterling, B. P. Flannery, Numerical recipes in Fortran 77: The art of scientific computing, 3^{nd} Edition, (Cambridge Univ. Press, New York, 2007), 1256 pages.

We claim:

1. A computer-implemented method for determining an asset value V of a company; said asset value V is characterized with a number of random jumps each having a random magnitude and a random time point; wherein: dV is a change of the asset value V, F₁(t) is a high frequency shot noise process, and F₂(t) is a low frequency shot noise process;
said method comprising the steps of:
using a computer, calculating said high frequency shot noise process F₁(t) and said low frequency shot noise process F₂(t) according to the following formula:
$${F}_{1 , 2} ( t ) = {\sum }_{k = 1}^{n} {η}_{1 , 2}^{( k )} {ϕ}_{1 , 2} ( t - {t}_{1 , 2 ( k )} ) , \qquad ( 18 )$$
wherein: η_{1,2}^{(k)} are random magnitudes of said high frequency shot noise process and said low frequency shot noise process statistically independent and distributed with probability densities p_{1,2}(η) respectively; t_{1,2(k)} are random time points homogeneously distributed on a time interval [t,T], so that a number of random jumps is n_{1,2} defined on the time interval [t,T], and said random magnitudes n_{1,2} obeys Poisson's law with two parameters: a high frequency λ₁ and a low frequency λ₂ respectively; and two response functions φ_{1,2} (t) wherein (φ_{1,2}(t)=0 for t<0);
using a computer, calculating said asset value V, in accordance with the following formula:
$$\frac{dV}{V} = {F}_{1} ( t ) dt + {F}_{2} ( t ) dt . \qquad ( 17 )$$

2. The method according to claim 1, wherein said company is further characterized with an equity S;
said method further defining a double jump mode with a market memory impact characterized with a stock price decline; said double jump mode is characterized with a superposition of said high frequency shot noise process F₁(t) and said low frequency shot noise process F₂(t);
wherein said equity S is calculated in accordance with the following system of equations:
$$\{ \begin{matrix}S = {VL}_{1} ( l ) - D exp ( - r ( T - t ) ) {L}_{2} ( l ) \\ \sqrt{{λ}_{1 S}} \cdot {δ}_{1 S} S = {L}_{1} ( l ) \sqrt{{λ}_{1}} \cdot {δ}_{1} V \\ \sqrt{{λ}_{2 S}} \cdot {δ}_{2 S} S = {L}_{2} ( l ) \sqrt{{μ}_{2}} \cdot {δ}_{2} V , \end{matrix} \qquad ( 19 )$$
wherein:
D is a book value of debt due at a maturity time T, r is a risk free interest rate, T−t is time to maturity, L₁(l) and L₂(l) are functions defined by the following formulas:
$$\begin{matrix}{L}_{1} ( l ) = \frac{1}{2 π} exp \{ - {\int }_{0}^{T - t} ( {λ}_{1} {ς}_{{m}_{1}} ( τ ) + {λ}_{2} {ς}_{{m}_{2}} ( τ ) ) dτ \} {\int }_{- ∞}^{l} {dz \int }_{- ∞}^{∞} {dke}^{ikz - z} exp \{ - {\int }_{0}^{T - t} ( {λ}_{1} {ξ}_{{m}_{1}} ( k , τ ) + {λ}_{2} {ξ}_{{m}_{2}} ( k , τ ) ) dτ \} , \\ and & ( 20 ) \\ {L}_{2} ( l ) = \frac{1}{2 π} {\int }_{- ∞}^{l} {dz \int }_{- ∞}^{∞} {dke}^{ikz - z} exp \{ - {\int }_{0}^{T - t} ( {λ}_{1} {ξ}_{{m}_{1}} ( k , τ ) + {λ}_{2} {ξ}_{{m}_{2}} ( k , τ ) ) dτ \} , & ( 21 )\end{matrix}$$
with an assumption that λ_{1,2}≅λ_{1,2S}, l is defined as follows:
$$l = ln \frac{V}{D} + r ( T - t ) - {\int }_{0}^{T - t} ( {λ}_{1} {ς}_{{m}_{1}} ( τ ) + {λ}_{2} {ς}_{{m}_{2}} ( τ ) ) d τ , \qquad ( 22 )$$
wherein four functions ζₘ_{_{1,2}}(τ) and ξₘ_{_{1,2}}(k) calculated as:
$$\begin{matrix}{ς}_{{m}_{1 , 2}} ( τ ) = {\int }_{- ∞}^{∞} d η {p}_{1 , 2} ( η ) ( {e}^{η {m}_{1 , 2} ( τ )} - 1 ) , & ( 23 ) \\ {ξ}_{{m}_{1 , 2}} ( k ) = {\int }_{- ∞}^{∞} d η {p}_{1 , 2} ( η ) ( {e}^{ik η {m}_{1 , 2} ( τ )} - 1 ) , & ( 24 )\end{matrix}$$
wherein said four functions ζₘ_{_{1,2}}(τ) and ξₘ_{_{1,2}}(k) each includes a respective memory function m₁(t) or m₂(t) defined as:
m₁(t)=1−exp(−αt), (25)
and
m₂(t)=1−exp(−βt), (26)
wherein α is an inverse characteristic time of the stock price decline under impact of the high frequency shot noise F₁(t); and β is an inverse characteristic time of the stock price decline under impact of the low frequency shot noise F₂(t);
p_{1,2}(η) are two probability density functions defined as:
$${p}_{1 , 2} ( η ) = \frac{1}{\sqrt{2 {πδ}_{1 , 2}^{2}}} exp \{ - \frac{{( η - {v}_{1 , 2} )}^{2}}{2 {δ}_{1 , 2}^{2}} \} , \qquad ( 27 )$$
and wherein:
ν_{1,2} are means of the random magnitudes of said number of random jumps; and δ_{1,2} are variances of the random magnitudes of said number of random jumps.

3. The method according to claim 1, wherein said company is further characterized with an equity S; said method further defining a jump-diffusion mode with a market memory impact characterized with a stock price decline; said jump-diffusion mode is characterized with a superposition of said high frequency shot noise process F₁(t) subjected to steps for diffusion approximating and said low frequency shot noise process F₂(t),
wherein said equity S is calculated in accordance with the following system of equations:
$$\{ \begin{matrix}S = {VL}_{1} ( {l}_{diff} ) - D exp ( - r ( T - t ) ) {l}_{2} ( {l}_{diff} ) \\ \sqrt{{λ}_{S}} \cdot {δ}_{S} S = {L}_{1} ( {l}_{diff} ) \sqrt{λ} \cdot δ V \\ {σ}_{S} S = {L}_{2} ( {l}_{diff} ) σ V , \end{matrix} \qquad ( 28 )$$
wherein D is debt at maturity time T, r is a risk free interest rate, T−t is time to maturity, the functions L₁(l_{diff}) and L₂(l_{diff}) are calculated using the following equations:
$$\begin{matrix}{L}_{1} ( l ) {\to }_{diff} {L}_{1} ( {l}_{diff} ) = \frac{1}{2 π} exp \{ - \frac{{σ}_{α}^{2} ( T - t )}{2} - {\int }_{0}^{T - t} {λ}_{2} {ς}_{{m}_{2}} ( τ ) d τ \} \times {\int }_{- ∞}^{{l}_{diff}} dz {\int }_{- ∞}^{∞} {dke}^{ikz - z} exp \{ - \frac{{σ}_{α}^{2} {k}^{2} ( T - t )}{2} - {\int }_{0}^{T - t} {λ}_{2} {ξ}_{{m}_{2}} ( k , τ ) d τ \} , \\ and & ( 29 ) \\ {L}_{2} ( l ) {\to }_{diff} {L}_{2} ( {l}_{diff} ) = \frac{1}{2 π} exp \{ - \frac{{σ}_{α}^{2} ( T - t )}{2} - {\int }_{0}^{T - t} {λ}_{2} {ς}_{{m}_{2}} ( τ ) d τ \} \times {\int }_{- ∞}^{{l}_{diff}} dz {\int }_{- ∞}^{∞} {dke}^{ikz - z} exp \{ - \frac{{σ}_{α}^{2} {k}^{2} ( T - t )}{2} - {\int }_{0}^{T - t} {λ}_{2} {ξ}_{{m}_{2}} ( k , τ ) d τ \} , & ( 30 )\end{matrix}$$
where parameter l_{diff} is defined by
$${l}_{diff} = ln \frac{V}{D} + ( r - \frac{{σ}_{α}^{2}}{2} ) ( T - t ) - {\int }_{0}^{T - t} ( {λ}_{2} {ς}_{{m}_{2}} ( τ ) ) d τ , \qquad ( 31 )$$
with σ_{α}² defined by
σ_{α}²=σ²b_{T-t}^{α}, (32)
wherein σ is a standard deviation of said asset value V, calculated by the following formula:
σ=(1/Δ)σ_{S}(S/V), (33)
and wherein Δ defined is calculated as Δ=N(d₁^{α}), where
$$\begin{matrix}N ( {d}_{1}^{ α} ) = \frac{1}{\sqrt{2 π}} {\int }_{- ∞}^{{d}_{1}^{ α}} dw exp ( - \frac{{w}^{2}}{2} ) , & ( 34 ) \\ and & \\ {b}_{T - t}^{α} = 1 - 2 ( \frac{{e}^{- 2 α ( T - t )} - 1}{4 α ( T - t )} - \frac{{e}^{- α ( T - t )} - 1}{α ( T - t )} ) , & ( 36 )\end{matrix}$$
wherein α is an inverse characteristic time of the stock price decline under impact of the high frequency shot noise F₁(t); and function ζₘ_{₂}(τ) is defined by the following formulae:
$${ϛ}_{{m}_{2}} ( τ ) = {\int }_{- ∞}^{∞} d η {p}_{2} ( η ) ( {e}^{η {m}_{2} ( τ )} - 1 ) , \qquad ( 37 )$$
p₂(η) is a probability density function defined as:
$${p}_{2} ( η ) = \frac{1}{\sqrt{2 {πδ}_{2}^{2}}} exp \{ - \frac{{( η - {v}_{2} )}^{2}}{2 {δ}_{2}^{2}} \} , \qquad ( 38 )$$
wherein ν₂ is a mean of the random magnitudes of said random jumps; δ₂ is a variance of the random magnitudes of said of random jumps; and a memory function m₂(t) is defined as:
m₂(t)=1−exp(βt), (26)
wherein β is an inverse characteristic time of the stock price decline under impact of the low frequency shot noise F₂(t).

4. The method according to claim 1, wherein said company is further characterized with an equity S;
said method further defining a diffusion mode with a market memory impact characterized with a stock price decline; wherein said equity S is calculated in accordance with the following equation:
S=VN(d₁^{α})−Dexp(−r(T−t))N(d₂^{α}), (38)
wherein N(d_{1,2}^{α}) is a normal cumulative probability distribution function calculated as
$$N ( {d}_{1 , 2}^{ α} ) = \frac{1}{\sqrt{2 π}} {\int }_{- ∞}^{{d}_{1 , 2}^{ α}} dw exp ( - \frac{{w}^{2}}{2} ) , \qquad ( 39 )$$
wherein d₁^{α} and d₂^{α} are calculated as:
d₁^{α}=[ln(V/D)+(r+σ²b_{T-t}^{α}/2)(T−t)]/σ\sqrt{b_{T-t}^{α}(T−t)}, (35)
d₂^{α}=[ln(V/D)+(r−σ²b_{T-t}^{α}/2)(T−t)]/σ\sqrt{b_{T-t}^{α}(T−t)}, (41)
wherein D is debt at maturity time T, r is a risk free interest rate, T−t is time to maturity, a is a standard deviation of said asset value V, calculated by the following formula:
σ=(1/Δ)σ_{S}(S/V), (42)
and wherein Δ is calculated as Δ=N(d₁^{α}), and b_{T-t}^{α} is calculated as:
$${b}_{T - t}^{α} = 1 - 2 ( \frac{{e}^{- 2 α ( T - t )} - 1}{4 α ( T - t )} - \frac{{e}^{- α ( T - t )} - 1}{α ( T - t )} ) , \qquad ( 43 )$$
and wherein α is an inverse characteristic time of the stock price decline under impact of the high frequency shot noise F₁(t).

5. The method of claim 2, further characterized with a probability of default P_{default} calculated in accordance with the following formula:
P_{default}=1−L₂(l), (44)
wherein L₂(l) is a mathematical function defined by the following formula:
$${L}_{2} ( l ) = \frac{1}{2 π} {\int }_{- ∞}^{l} dz {\int }_{- ∞}^{∞} {dke}^{ikz} exp \{ - {\int }_{0}^{T - t} ( {λ}_{1} {ξ}_{{m}_{1}} ( k , τ ) + {λ}_{2} {ξ}_{{m}_{2}} ( k , τ ) ) dτ \} . \qquad ( 21 )$$

6. The method of claim 2, further characterized with a distance to default dd(T-t) calculated in accordance with the following formula:
$$dd ( T - t ) = l = ln \frac{V}{D} + r ( T - t ) - {\int }_{0}^{T - t} ( {λ}_{1} {ϛ}_{{m}_{1}} ( τ ) + {λ}_{2} {ϛ}_{{m}_{2}} ( τ ) ) d τ . \qquad ( 45 )$$

7. The method of claim 2, further characterized with a credit spreads of the company calculated in accordance with the following formula:
$$s = - \frac{1}{T - t} ln \{ {L}_{2} ( l ) + \frac{V}{D} exp ( r ( T - t ) ) ( 1 - {L}_{2} ( l ) ) \} - r . \qquad ( 46 )$$

8. The method of claim 2, further characterized with an expected credit loss ECL of the company calculated in accordance with the following formula:
ECL=(1−L₂(l)){D−Vexp(r(T−t))L₁(l)/L₂(l)}. (47)

9. The method of claim 2, further characterized with a recovery rate RR of the company calculated in accordance with the following formula:
$$RR = \frac{{Ve}^{r ( T - t )}}{D} \frac{{L}_{1} ( l )}{{L}_{2} ( l )} . \qquad ( 48 )$$

10. The method of claim 3, further characterized with a probability of default P_{default} calculated in accordance with the following formula:
P_{default}=1−L₂(l_{diff}). (49)

11. The method of claim 3, further characterized with a distance to default dd(T-t) calculated in accordance with the following formula:
$$dd ( T - t ) = l = ln \frac{V}{D} + ( r - \frac{{σ}_{α}^{2}}{2} ) ( T - t ) - {\int }_{0}^{T - t} {λ}_{2} {ϛ}_{{m}_{2}} ( τ ) d τ . \qquad ( 50 )$$

12. The method of claim 3, further characterized with a credit spreads of the company calculated in accordance with the following formula:
$$s = - \frac{1}{T - t} \{ ln \{ {L}_{2} ( {l}_{diff} ) + \frac{V}{D} exp ( r ( T - t ) ) ( 1 - {L}_{2} ( {l}_{diff} ) ) \} - r . \qquad ( 51 )$$

13. The method of claim 3, further characterized with an expected credit loss ECL of the company calculated in accordance with the following formula:
ECL=(1−L₂(l_{diff})){D−Vexp(r(T−t))L₁(l_{diff})/L₂(l_{diff})}. (52)

14. The method of claim 3, further characterized with a recovery rate RR of the company is calculated in accordance with the following formula:
$$RR = \frac{{Ve}^{r ( T - t )}}{D} \frac{{L}_{1} ( {l}_{diff} )}{{L}_{2} ( {l}_{diff} )} . \qquad ( 53 )$$

15. The method of claim 4, further characterized with a probability of default P_{default} calculated in accordance with the following formula:
P_{default}=1−N(d₂^{α}). (54)

16. The method of claim 4, further characterized with a distance to default dd(T-t) calculated in accordance with the following formula:
$$dd ( T - t ) = l = ln \frac{V}{D} + ( r - \frac{{σ}^{2} {b}_{T - t}^{α}}{2} ) ( T - t ) . \qquad ( 55 )$$

17. The method of claim 4, further characterized with a credit spreads of the company is calculated in accordance with the following formula:
$$s = - \frac{1}{T - t} ln \{ N ( {d}_{2}^{ α} ) + \frac{V}{D} exp ( r ( T - t ) ) ( 1 - N ( {d}_{2}^{ α} ) ) \} - r . \qquad ( 56 )$$

18. The method of claim 4, further characterized with an expected credit loss ECL of the company is calculated in accordance with the following formula:
ECL=N(−d₂^{α}){D−Vexp(r(T−t))N(−d₁^{α})/N(−d₂^{α})}. (57)

19. The method of claim 4, further characterized with a recovery rate RR of the company is calculated in accordance with the following formula:
$$RR = \frac{{Ve}^{r ( T - t )}}{D} \frac{N ( - {d}_{1}^{α} )}{N ( - {d}_{2}^{α} )} . \qquad ( 58 )$$
